(19) United States
(12) Patent Application Publication
(10) Pub. No.: US 2020/0184167 A1
(43) Pub. Date: Jun. 11, 2020

(54) WORKFLOW OPTIMIZED SLIDE SCANNING

(71) Applicant: KONINKLIJKE PHILIPS N.V., Eindhoven (NL)

(72) Inventors: Jelte Peter VINK, Waalre (NL); Baas HULSKEN, Eindhoven (NL); Hans van WIJNGAARDEN, Eindhoven (NL)

(73) Assignee: Koninklijke Philips N.V., Eindhoven (NL)

(21) Appl. No.: 16/320,760

(22) PCT Filed: Jul. 28, 2017
(86) PCT No.: PCT/EP2017/069101

§ 371 Date: Jan. 25, 2019

(30) Foreign Application Priority Data
Jul. 28, 2016 (EP) 16181585.7

(51) Int. Cl. G06K 7/14; G06K 7/10; G02B 21/36; G02B 21/34; G01N 35/00

(52) U.S. Cl. CPC G06K 7/1413; G06K 7/10722; G02B 21/36; G02B 21/34; G01N 2035/0094; G01N 35/00732; G01N 35/0095; G01N 2035/00831; G01N 35/00029

(57) ABSTRACT

The present invention relates to imaging microscope slides. In order to further improve a workflow for slide scanning, a system (10) for imaging microscope slides is provided that comprises a store area unit (12), a code readout unit (14), and a data interface unit (16). The store area unit is configured to receive a plurality of slides, each slide having a code comprising slide related information. The code readout unit is configured to detect the respective codes of a stored plurality of slides. The data interface unit is configured to provide the detected codes for a generation of a code inventory and to receive a determined scan order based on the code inventory.

### FIELD OF THE INVENTION

The present invention relates to imaging microscope slides, and relates in particular to a system for imaging microscope slides and to a method for optimizing workflow in imaging microscope slides.

### BACKGROUND OF THE INVENTION

Microscope slides may be used for scanning of probes, such as tissue slices provided on a substrate layer for scanning purposes. The probes on the slides may be pre-treated for achieving better image data, e.g. staining procedures may be applied. The scanning generates and hence provides images or at least image data of the respective slides. The slides may be provided on racks, e.g. a number of twenty slides or more carried by a common rack. The slide scanning may be provided as an automated process. For example, WO 2014/205557 A1 describes taking preview images of microscope slides. The preview is used for adapting the respective settings and also for setting scan priority for each slide tray. However, it has been shown that in particular with a large number of slides to be scanned, this still means a cumbersome process.

### SUMMARY OF THE INVENTION

There may be a need to further improve the workflow for slide scanning.

The object of the present invention is solved by the subject-matter of the independent claims; further embodiments are incorporated in the dependent claims. It should be noted that the following described aspects of the invention apply also for the system for imaging microscope slides and for the method for optimizing workflow in imaging microscope slides.

According to the present invention, a system for imaging microscope slides is provided. The system comprises a store area unit, a code readout unit, and a data interface unit. The store area unit is configured to receive a plurality of slides, each slide having a code comprising slide related information. The code readout unit is configured to detect the respective codes of a stored plurality of slides; the data interface unit is configured to provide the detected codes for a generation of a code inventory and to receive a determined scan order based on the code inventory.

This allows to achieve a scanning order that may be optimized e.g. in view of workflow aspects. For example, slides related to a certain patient, or certain type of exam, may be scanned first if such results are required as priority.

In an example, the data interface unit is configured to provide a code inventory based on the detected codes. In another example, the generation of a code inventory is provided externally, e.g. remote from a scanning unit. In a further example, the generation of a code inventory is provided internally a scanning arrangement.

In any case, the scan order is determined by a processing unit and based on the detected codes of the stored slides.

According to an example, the code readout unit is provided separately to an imaging unit for scanning slides.

As a result, a scan order can be determined before the slides are transferred to an imaging unit, such as a slide scanner.

According to an example, a plurality of slides is provided that each comprise a detectable code.

Hence, all slides can be determined by their code and a respective scan order can consider the complete set of slides. For example, based on the code information, slides can be assigned to a certain scan sequence.

According to an example, the system further comprises a scanning unit that comprises at least one scan engine for scanning microscope slides. Further, the scanning unit is configured to scan the plurality of slides received in the store area in the determined scan order.

This leads to a scanning result according to the scan order. Hence, it is possible to achieve scanning results with priorities without the need to first physically sort the slides in a particular order. The scanning takes place in an order that is independent from an order of the slides in the racks, for example.

In an example, a device is provided for the handling of the slides. For example, the respective handling can be provided by a handler.

According to an example, the store area unit comprises at least one receptacle for receiving a rack with inserted slides. In an option, a rack with inserted slides is provided.

Further, as an option, several racks may be provided in the store area unit in order to allow the scanning of a large number of slides.

According to an example, the system further comprises a handling unit for individually transferring a slide between a rack and the scanning unit in order to scan the slide and to place the slide afterwards, e.g. back into the rack or also somewhere else for physical storing purposes of the slides. In an option, the identification unit is integrated in the handling unit.

In another example, instead of placing slides back into a rack, the slides can also be provided in an output area.

The handling unit allows for the provision of the slides to the scanning unit according to the determined scan order.

According to the present invention, a method for optimizing workflow in imaging microscope slides is provided. The method comprises the following steps:

a) providing a plurality of slides stored in a store area unit, each slide having a code comprising slide related information;
b) detecting the respective codes of the stored plurality of slides;
c) generating of the code inventory; and
d) determining a scan order based on the code inventory.

In an example, it is further provided a step e) of scanning the stored plurality of slides based on the determined scan order.

In an example, after making an inventory and determining the scan order, it is provided the subsequent steps of analysing the slide(s) in order to derive imaging parameters necessary or useful for the scan (e.g. focus points, etc.) and scanning the slide(s) taking the parameters into account.

In an example, it is provided that an analysis of the slide comprises the sub-step of making a pre-scan, e.g. a low resolution image, of the sample of the slide. Afterwards, a scan is performed at a higher resolution, e.g. 20 times higher or 40 times higher. In an example, the pre-scan image does not include the code.

According to an aspect, each slide is provided with a code that contains information related to the slide. The codes are detected by a reader in order to determine a certain scan order of the slides. For the scan order, the user can set priority data and the scan order considers these when determining the scan order.

These and other aspects of the present invention will become apparent from and be elucidated with reference to the embodiments described hereinafter.

### BRIEF DESCRIPTION OF THE DRAWINGS

Exemplary embodiments of the invention will be described in the following with reference to the following drawings:

FIG. 1 shows a schematic setup of an example of a system for imaging microscope slides.

FIG. 2 shows a further example of a system for imaging microscope slides.

FIG. 3 shows another example of a system for imaging microscope slides.

FIG. 4 shows a still further example of a system for imaging microscope slides.

FIG. 5 shows an example of a method optimizing workflow in imaging microscope slides.

### DETAILED DESCRIPTION OF EMBODIMENTS

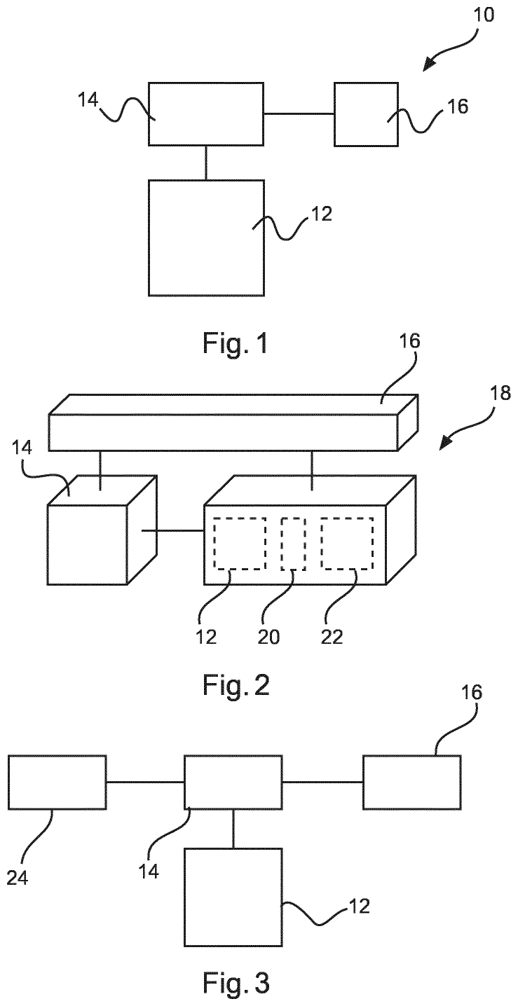

FIG. 1 shows a schematic setup of an example of a system 10 for imaging microscope slides. The system 10 comprises a store area unit 12, a code readout unit 14, and a data interface unit 16. The store area unit 12 is configured to receive a plurality of slides, each slide having a code comprising slide related information. The code readout unit 14 is configured to detect the respective codes of a stored plurality of slides; and the data interface unit 16 is configured to provide the detected codes for a generation of a code inventory and to receive a determined scan order based on the code inventory.

In an example, the system for imaging microscope slides is used in digital pathology.

The code is not a pre-scan of the slide, i.e. the tissue part of the slide, or in other words, the image to be taken itself, but an additional piece of information, i.e. the code is not probe-image-content based. The code is independent from the image content of the slide, i.e. the probe or tissue content.

In an example, the code is not acquired by the same scanning principle as used for providing the scan. However, the code may be read out in an optical way that uses an optical image detecting apparatus that is also used for scanning the slides.

In an example, the determined scan order is based on code information only.

The code can be a barcode, a dot pattern, or another code detectable by a camera or other optical detecting apparatus.

In another version, the code is provided based on electromagnetical information transfer, for example based on near field communication (NFC).

The “slide related information” may include a unique identifier that can be used to retrieve slide related information from an external system, such as an LIS (laboratory information system).

The term “slides” relates to probes or samples, such as tissue probes or other biological sample or specimen, which probes or samples are arranged on a substrate such as glass or other suitable carrier/support material for imaging purposes. The imaging may be provided by different image generation procedures. The slide may for example comprise two glass layers between which the sample or probe is arranged.

The tissue sample may be pre-treated for imaging purposes, such as stained or treated with particular substances in order to better visualize the different tissue or sample areas.

The slides may be provided to comprise one or more probes or samples on each slide. The term slide refers to a physical entity that is suitable for providing and keeping material of interest, such as storing probes on slides in a rack or other carrier provided for storing a plurality of slides. The slides are also provided to be handled in a scanning apparatus.

The term “scanning” refers to image generation of the probe or sample carried by the slide. The scanning may be arranged by providing a relative motion between the slide and an imaging system or imager. For example, the slide may be moved along a light source and camera setup for generating an image of the complete slide. In another example, a light source and camera setup is moved along the slide. In a further example, both are mutually moved in relation to each other.

The term “scan order” relates to the arrangement of slides sequentially scanned one after the other. This order can be along the sorting of the scans in a rack or other arrangement holding the slides. In an example, the sorting order relates to criteria that are related to the image content, independently of the slides' arrangement in a carrier such as a rack or tray.

In an example, the scan order is determined by assigning higher priority to slides relating to same criteria, such as the same case.

In an example, the determined order is continuously updated to reflect changing priorities in the laboratory.

As an option (not further shown) it is provided that the code readout unit 14 comprises a graphical code reader device to detect graphical codes provided on each slide.

As another option (also not further shown) it is provided that the code readout unit 14 comprises a wireless code readout device to detect non-graphical code provided by each slide.

For example, the code is provided via an RFID-tag (radio frequency identification tag), or an NFC tag (near field communication tag).

The codes may be provided as barcode, pixel code, numerical code, alphabetical code or the like.

In an example, as indicated above the slides are digital pathology slides.

FIG. 2 shows an example where the code readout unit 14 is provided separately to an imaging unit 18 for scanning slides. The imaging unit 18 may comprise a handler 20 for handling the slides, for example referred to as a gripper, and an imager 22, for example referred to as imaging or scanning engine. As an option, the store area unit 12 may be provided within a common housing of the imaging unit 18.

In a further option (not shown), the handler 20 (or gripper) is provided independent from the imaging unit 18.

In a further option (not shown), the handler 20 (or gripper) is provided independent from the imager 22.

In an example, the determined scan order is used to provide an accurate estimation of an expected scan flow and its scanning progress.

For example, the determined scan order is communicated to a system like an IMS/LIS (information or image management system/laboratory information system) or other information system, so that an accurate estimation can be made of the scan flow, in order to determine when a case is expected to be scanned and available for further steps.

In another example, the determined scan order is aligned or at least communicated with a system that tracks the availability of e.g. pathologists.

According to an example, a plurality of slides is provided that each comprise a detectable code.

FIG. 3 shows an example where a processing unit 24 is provided that is configured to provide a code inventory of the stored plurality of slides and to determine a scan order based on the code inventory.

In an example, the processing unit 24 is connected to the code readout unit 14, i.e. the communication is provided via the code readout unit 14 (as indicated in FIG. 3).

In another example, the processing unit 24 is connected to the data interface unit 16, which data interface unit 16 is then connected to the code readout unit 14, i.e. the communication is provided via the data interface unit 16 (not shown).

In an example, the code is provided separate to a slide image portion comprising tissue sample to be imaged.

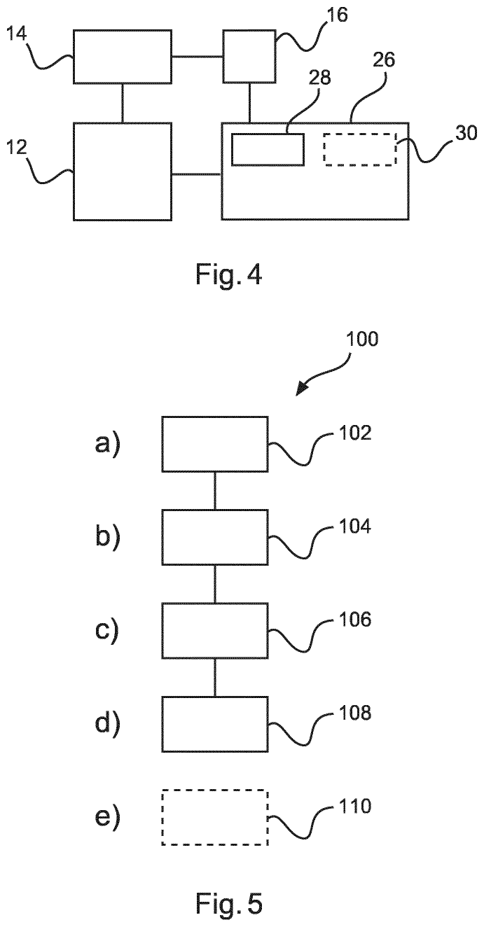

FIG. 4 shows an example where the system further comprises a scanning unit 26 that comprises at least one scan engine 28 for scanning microscope slides. Further, the scanning unit 26 is configured to scan the plurality of slides received in the store area in the determined scan order.

The term “scan engine” relates to an imager arranged for scanning the slides. In an example, the scan engine comprises a light source and a camera. The scan engine comprises at least one image data generating unit.

The scanning unit is configured to perform a main scan for each of the slides. The scanning unit may also be configured to perform a pre-scan for each of the slides to determine image related parameters, for example focus parameters, stain, or color information.

The code readout unit may be provided integrally with the scanning unit, for example, the code readout may be provided by the same optical detection unit, e.g. a camera.

In an example, indicated in FIG. 4 as an option, at least two different scan engines are provided. This is indicated with a second scan engine 30. As another option, a selection of the scan engine is provided based on the detected code.

In an example, a bright field scan engine is provided, and a fluorescent scan engine.

The term “bright field scan engine” relates to an imager that provides image data based on an optical microscopy illumination technique that uses transmitting illumination of the sample or probe. Bright light, e.g. white light is used for detecting different sample properties along the sample due to different absorbance.

The term “fluorescent scan engine” relates to an imager that provides image data based on fluorescence spectroscopy, also referred to as spectrofluorometry or fluorometry. Fluorescence spectroscopy relates to analyzing fluorescence from a sample or probe. For example, a light beam, which may be provided as an UV-light beam, excites some types of tissue which then emit light. This can be visible or non-visible by human eye. However, it can be detected by a detector such as a camera.

In an example (not further shown), the store area unit comprises at least one receptacle for receiving a rack with inserted slides. Optionally, a rack with inserted slides is provided.

The system may further comprise a handling unit for individually transferring a slide between a rack and the scanning unit in order to scan the slide and to place the slide afterwards else, like an output rack or output area. Optionally, the identification unit is integrated in the handling unit.

The handling unit is also referred to as gripping unit, or handler or gripper.

In an example, the handling unit is configured to handle one slide at a time.

In another example, the handling unit is configured to handle two or more slides at a time, e.g. a dual gripper.

The code inventory may be updated when, for example, a new rack is inserted in the store, or a new slide is inserted in the rack, or updated information is received from an interface.

As a further option, the code inventory may be updated when scan related information is provided by a scan engine, e.g. how long it takes to scan, or even if one of the scan engines has a failure or malfunction.

In an example, the updated information received from the interface is update information from an LIS.

In an example, the code inventory is updated when a priority change is given by the operator via the user interface of the scanner, or based on other system input.

In an example, an interface is provided to provide criteria for the determination of the scan order.

For example, a user interface may be provided that is configured to pre-set criteria for the determination of the scan order.

For example, the interface is provided to assign priority to slides related to at least one common predetermined criteria of the group of: patient, type of tissue, type of preparation of the tissue.

In an example, first priority in the scan order is assigned to slides of the same case, e.g. of the same patient at a certain time range and/or certain body region.

The order may be determined based on at least one of the following, i.e. one of the group of availability of scan engine or pathology expertise, priority, HIS/LIS information, trying to complete a case, and taking into account how long it would take to scan a slide.

FIG. 5 shows a method 100 for optimizing workflow in imaging microscope slides is provided. The method comprises the following steps:

In a first step 102, also referred to as step a), a plurality of slides stored in a store area unit is provided. Each slide has a code comprising slide related information.

In a second step 104, also referred to as step b), the respective codes of the stored plurality of slides are detected.

In a third step 106, also referred to as step c), the code inventory is generated.

In a fourth step 108, also referred to as step d), a scan order based on the code inventory is determined.

In an example, it is further provided a fifth step 110, also referred to as step e), of scanning the stored plurality of slides based on the determined scan order.

In an option, a loop is provided that provides that the order of the slides can be optimized continuously.

The system for imaging microscope slides, as described in various examples and options, can be provided integrated with a scanner that is capable of making an inventory scan of stored slides

The system for imaging microscope slides, as described in various examples and options, can be also provided as an add-on to a scanner that is capable of making an inventory scan of stored slides. For example, the system for imaging microscope slides, as described in various examples and options, can be provided for retrofitting and hence upgrading existing scanners.

The information is then used, combined with information e.g. from the LIS/HIS (health information services)/IMS, to optimize the order in which the slides are scanned. By that, for example, a case (consisting of multiple slides) can be scanned sequentially, independently of the order of the store. Furthermore, specific slides can be prioritized. This improves the workflow as it reduces the time a case is waiting to be examined by the pathologist.

A digital pathology scanner may comprise the following components: Optical engine, to digitize the slides; graphical user interface, to allow operating the scanner; slide storage, to store racks with microscope slides; and handler, to transport the microscope slides from the slide storage to the optical engine and back.

For example, the used racks have a capacity of e.g. 20 slides, which can be processed in the determined order. Furthermore, the racks themselves can also be processed in a determined order. In an example, particular racks can manually be given priority using the GUI.

Accordingly, the slides can be scanned in an optimal order. For example, this allows scanning considering priority cases, which should be processed (and examined by the pathologist) as soon as possible, or cases consisting of multiple microscope slides, as the pathologist needs all digital images, before he can start examining the case.

For example, it is provided to allow to prioritize a specific rack (such that all microscope slides in the prioritized rack will be scanned first) using the GUI (if the scanner supports this feature). Or it is provided to allow to manually optimize the order of the slides in the racks, as well as the racks in the slide storage of the scanner.

The add-on to the scanner is capable of making an inventory scan of the store, but without the need to make a pre-scan, which would require to then analyze or assess image content. Contrary, a barcode or the like of each slide is determined, before actually acquiring the slide. This information is used, combined with information from the LIS/HIS/IMS, to optimize the order in which the slides are scanned. By that, a case (consisting of multiple slides) can be scanned sequentially, independently of the order of the slides in the store. Then, the time to complete this case is limited, as the pathologist does not have to wait a long time until the last slide is digitized. Furthermore, specific slides can be given priority in the LIS/HIS/IMS, such that these specific slides are digitized first. This avoids labor intensive activity, to manually put the slides a specific order in the racks and the racks in a specific order in the slide storage.

To determine slide IDs, e.g. a barcode scanner is used; the barcode scanner may be provided in an optical engine of the scanner. In another example, a barcode scanner is provided attached to a handler or gripper. Each slide may be picked by the gripper, identified by the barcode scanner and put back in the store. Based on the slide IDs, combined with information from the IMS/LIS/HIS, the optimal order can be determined.

In case a new slide rack is positioned in the scanner, the digital pathology scanner detects this, and may perform an inventory scan on the new slide racks. The order may be updated, based on this information.

In case the scanner consists of multiple (different) scan engines (e.g. a bright field scan engine and a fluorescent scan engine), based on the slide ID, the applicable scan engine can be selected.

In another example, the order of the slides can be determined by the availability of the pathologists (i.e. integration with a dispatching tool). In case a slide requires a re-scan (e.g. the image quality is insufficient), it is provided as an option to perform the rescan directly.

Although the slides may be provided stacked in a tray in a given (or physically sorted) order, due to the determined scanning order, the slides are not scanned in a fixed order, i.e. an order as sorted, but in an order based on determined criteria.

The system for imaging microscope slides and the method for optimizing workflow in imaging microscope slides is provided e.g. for application in digital pathology and in the context of pathology lab workflow.

It has to be noted that embodiments of the invention are described with reference to different subject matters. In particular, some embodiments are described with reference to method type claims whereas other embodiments are described with reference to the device type claims. However, a person skilled in the art will gather from the above and the following description that, unless otherwise notified, in addition to any combination of features belonging to one type of subject matter also any combination between features relating to different subject matters is considered to be disclosed with this application. However, all features can be combined providing synergetic effects that are more than the simple summation of the features.

While the invention has been illustrated and described in detail in the drawings and foregoing description, such illustration and description are to be considered illustrative or exemplary and not restrictive. The invention is not limited to the disclosed embodiments. Other variations to the disclosed embodiments can be understood and effected by those skilled in the art in practicing a claimed invention, from a study of the drawings, the disclosure, and the dependent claims. In the claims, the word “comprising” does not exclude other elements or steps, and the indefinite article “a” or “an” does not exclude a plurality. A single processor or other unit may fulfil the functions of several items re-cited in the claims. The mere fact that certain measures are re-cited in mutually different dependent claims does not indicate that a combination of these measures cannot be used to advantage. Any reference signs in the claims should not be construed as limiting the scope.

1. A systems for imaging microscope slides, each slide comprising a sample and comprising a code which provides slide related information, the system comprising:
a store area unit;
a code readout unit; and
a data interface unit;
an imaging unit comprising at least one scanning engine for imaging microscope slides; and
a processing unit;
wherein the store area unit is configured to receive racks with a plurality of the slides therein;
wherein the code readout unit is configured to detect the respective codes of the slides in the racks without detecting the respective samples on these slides;
wherein the data interface unit is configured to provide the detected codes to the processing unit,
wherein the processing unit is configured to use the codes to generate a code inventory and to determine a scan order-based on the code inventory;
wherein the imaging unit is configured to perform a pre-scan of the slides in at least one of the racks based on the determined scan order, in order to obtain and analyze images of the samples on these slides and to determine respective image related parameters to be used for a main scan;
wherein the imaging unit is further configured to perform a main scan of the slides that have been pre-scanned, based on the scan order, and based on said respective image related parameters.

2. (canceled)

3. (canceled)

4. System according to claim 13, wherein the imaging unit is configured to perform said main scan of the slides at a higher resolution than the resolution of the pre-scan.

5. System according to claim 1, wherein the code readout unit comprises at least one of:
a graphical code reader device to detect graphical codes provided on each slide; and
a wireless code readout device to detect non-graphical code provided by each slide.

6. System according to claim 1, wherein the code readout unit is provided separately to the imaging unit for scanning slides.

7. (canceled)

8. System according to claim 1, further comprising:
a scanning unit;
wherein the scanning unit comprises at least two different scan engines for scanning microscope slides; and
wherein the scanning unit is configured to scan the plurality of slides received in the store area in the determined scan order, and wherein a selection of the scan engine is provided based on the detected code.

9. (canceled)

10. System according to claim 1, further comprising a handling unit for individually transferring a slide between a rack and the scanning unit in order to scan the slide and to place the slide afterwards;
wherein the identification unit is integrated in the handling unit.

11. System according to claim 1, wherein it is provided that the code inventory is updated when:
a new rack is inserted in the store;
a new slide is inserted in the rack;
updated information received from an interface; and/or
scan related information is provided by a scan engine.

12. System according to claim 1, wherein an interface is provided to provide criteria for the determination of the scan order;
wherein the interface is a user interface, which is configured to pre-set the criteria for the determination of the scan order; and/or
wherein the interface is provided to assign priority to slides related to at least one common predetermined criteria of the group of: patient, type of tissue, type of preparation of the tissue.

13. System according to claim 1, wherein the scan order is determined based on HIS/LIS information at least one of the following: availability of scan engine or pathology expertise, priority, HIS/LIS information, trying to complete a case, taking into account how long it would take to scan a slide.

14. A method for optimizing workflow in imaging microscope slides, each slide comprising a sample and comprising a code which provides slide related information, the method comprising the following successive steps:
a) providing a plurality of slides stored in racks of a store area unit;
b) detecting the respective codes of the stored plurality of slides in the racks without detecting the respective samples on these slides;
c) generating a code inventory;
d) determining a scan order based on the code inventory;
e) performing a pre-scan of the slides in at least one of the racks, based on the scan order to obtain respective images of the samples;
f) analyzing said images of the samples to determine respective image related parameters;
g) performing a main scan of the pre-scanned slides, based on the scan order and based on said respective image related parameters.

15. (canceled)

16. (canceled)

17. A method according to claim 14, wherein the main scan is made at a higher resolution than the pre-scan.

18. A method according to claim 11, further comprising the steps of selecting a scan engine to perform the pre-scan and the main scan based on the detected code.

19. A method according to claim 11, comprising the step updating the code inventory when:
i) a new rack is inserted in the store;
ii) a new slide is inserted in the rack;
iii) updated information received from an interface; and/or
iv) scan related information is provided by a scan engine

20. A method according to claim 11, comprising the determining the scan order based on at least one of the following:
availability of scan engine or pathology expertise, priority, HIS/LIS information, trying to complete a case, and taking into account how long it would take to scan a slide.

21. System according to claim 1, wherein the scan order is determined based on at least one of the following: availability of scan engine or pathology expertise, priority, trying to complete a case, taking into account how long it would take to scan a slide.

22. A method according to claim 16, wherein the main scan is made at a higher resolution than the pre-scan.
